(19) United States
(12) Patent Application Publication
(10) Pub. No.: US 2017/0124088 A1
(43) Pub. Date: May 4, 2017

(54) METHOD OF OPERATING A SOLUTION SEARCHING SYSTEM AND SOLUTION SEARCHING SYSTEM

(71) Applicants: Inventec (Pudong) Technology Corp., Shanghai (CN); Inventec Corporation, Taipei (TW)

(72) Inventors: Ying-Chih Lu, Taipei (TW); Tsai-Feng Chung, Taipei (TW)

(21) Appl. No.: 15/083,270

(22) Filed: Mar. 28, 2016

(30) Foreign Application Priority Data
Oct. 28, 2015 (CN) 201510713727.9

(51) Int. Cl. G06F 17/30

(52) U.S. Cl. CPC G06F 17/3053; G06F 17/30539; G06F 17/30554; G06F 17/30598

(57) ABSTRACT

A method of operating a solution searching system includes a utility server generating a model input file according to words in an issue description file, a model server generating a prediction solution classification according to the model input file and a data mining prediction model, a central server selecting a first user defined solution classification with a highest weighting of at least one of user defined solution classification stored in a relational database as a solution classification, a database server reading at least one solution from a big database according to the solution classification, and the central server outputting the at least one solution according to weighting of each of the solution.

### BACKGROUND OF THE INVENTION

1. Field of the Invention

This invention relates to a solution searching system and especially relates to a solution searching system using big data and data mining.

2. Description of the Prior Art

The success of a product may not only require technical research and design, but also great efforts of testing for ensuring the stability of the product. Especially for high-tech products that require high stability and high reliability, such as industrial instruments, mobile devices, work stations, personal computers or servers, the standard for quality testing is even stricter. When the products examined have issues, it may be needed to reproduce the issues, collect and analyze the related information, find out the root causes, propose solutions and to test the proposed solutions before one can actually confirm that the examined issues are solved. These processes can be time consuming and may cause the products to be late to market. Also, the processes may be dependent on the engineer's profession and experience. Namely, the degree of the engineer's profession and experience can largely affect the time required for the issue to be solved and also affect the quality of the solution. Therefore, the quality of the solutions is difficult to control. In addition, since it can be difficult to extend one's personal experience to another, it may require different engineers doing the same above processes to solve the same or similar issues, which can be very inefficient and cannot ensure that the engineer will find out the best solution all the time.

Moreover, for products of the same types, the possibility to find the same or similar issues can be rather high. Although the solutions may also be recorded or stored in some prior arts, it is still difficult to store the information systematically for the great variety of different issues, the great amount of data, and the different ways of the engineers to describe the issues. Therefore, the engineers still have difficulty finding the related solutions in practical, and the goal to share the engineer's experience still has way to go. How to let the engineers share their experiences with each other, find the possible solutions easily and improve the quality of solutions have become a critical issue.

### SUMMARY OF THE INVENTION

One embodiment of the present invention discloses a solution searching system. The solution searching system includes a big data database, a relational database, a utility server, a model running server, a database server, and a central controller server. The utility server is for generating an attribute description file according to a standard wording table and words in an issue description file, generating a predictor file according to the attribute description file, and generating a model input file according to the predictor file. The model running server is for generating a prediction solution classification according to the model input file and a first data mining prediction model. The database server is for reading at least one solution file from the big data database according a solution classification corresponding to the issue description file. The central controller server is for transferring the issue description file to the utility server when receiving the issue description file, transferring the model input file generated by the utility server to the model running server, choosing a first user defined solution classification with a highest weighting among the at least one user defined solution classification as the solution classification when there is at least one user defined solution classification stored in the relational database, transferring the solution classification to the database server, and outputting the at least one solution file read by the database server from the big data database sequentially according to a weighting of each solution file corresponding to the solution classification in the relational database.

Another embodiment of the present invention discloses a method for operating a solution searching system. The solution searching system includes a utility server, a model running server, a relational database, a big data database, and a central controller server. The method includes the central controller server transferring the issue description file to the utility server when the central controller server receives an issue description file, the utility server generating an attribute description file according to a standard wording table and words in the issue description file, the utility server generating a predictor file according to the attribute description file, the utility server generating a model input file according to the predictor file, the central controller server transferring the model input file to the model running server, the model running server generating a prediction solution classification according to the model input file and a first data mining prediction model, the central controller server choosing a first user defined solution classification with a highest weighting among the at least one user defined solution classification as a solution classification when there is at least one user defined solution classification stored in the relational database, the central controller server transferring the solution classification to the database server, the database server reading at least one solution file from the big data database according the solution classification, and the central controller server outputting the at least solution file read by the database server from the big data database sequentially according to a weighting of each solution file corresponding to the solution classification in the relational database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a solution searching system according to one embodiment of the present invention.

FIG. 2 shows a solution searching system according to another embodiment of the present invention.

FIGS. 3 and 4 show a method of operating the solution searching system in FIG. 1 according to one embodiment of the present invention.

### DETAILED DESCRIPTION

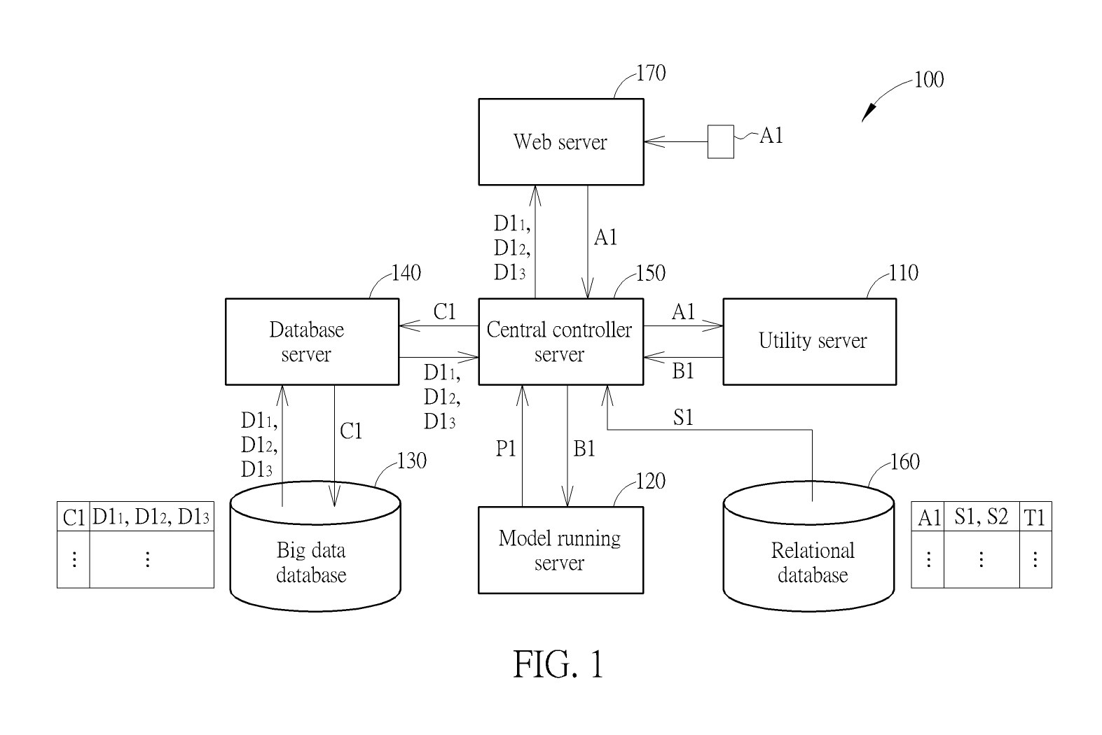

FIG. 1 shows a solution searching system 100 according to one embodiment of the present invention. The searching system 100 includes a utility server 110, a model running server 120, a big data database 130, a database server 140, a central controller server 150, and a relational database 160. The database server 140 and the big data database 130 can be servers and databases that can support systems of Hadoop Distribute File System (HDFS), Hadoop Map/Reduce, Hive or other database systems that are suitable for managing big data so the requirements of the solution searching system 100 for processing or storing big amounts of data rapidly can be achieved. The relational database 160, such as MySql or PostgreSql, is based on general file system for the central controller server 150 to store temporary and small amounts of data.

When a user wants to search solutions through the solution searching system 100, the user can input the issue description file A1 to the solution searching system 100. When the central controller server 150 receives the issue description file A1, the issue description file A1 can be transferred to the utility server 110. The issue description file A1 can describe information related to the products and the issues with words. The information may include the description of the system issue and phenomenon, sub system which the system issue belongs to, and the situation in which the issue is observed, namely how to reproduce the issue, but not limited to the information aforesaid. In some embodiments of the present invention, the issue description file A1 can use a fixed format, such as but not limited to csv, json, or xml, to list the information related to the issues so that the utility server 110 can identify the information stated in the issue description file A1 precisely.

In some embodiments of the present invention, the utility server 110 can generate an attribute description file according to the issue description file A1. The attribute description file can include a plurality of attributes; each of the attributes is composed of an attribute name and an attribute value as a pair. In some embodiments of the present invention, the attributes can be described in a format of json. If the information related to the system issues in the issue description file A1 is not listed in a fixed format, the utility server 110 can also use regular expressions to identify words in the attributes to derive the attribute values. Furthermore, the utility server 110 can compare the words in the issue description file A1 with a standard wording table to generate the attribute description file. Table 1 shows parts of the standard wording table according to one embodiment of the present invention. According to the standard wording table, the words and phrases that have the same meaning can be standardized so the expression of the syntax in the attribute description file can be more efficient. In addition, to avoid the ambiguity of the syntax in the attribute description file, all the values of the attribute may be represented with lowercase.

TABLE 1

| | |
|---|---|
| “chip set” | “cs” |
| “chipset” | “cs” |
| “operation system” | “os” |
| “operation systems” | “os” |
| “system board” | “sb” |
| “mother board” | “sb” |
| “basic input output system” | “bios” |
| “memory reference code” | “mrc” |
| “inter-integrated circuit”, “i2c” | “i2c” |

Since the selection of the attributes may influence the accuracy of the solution searching system 100, the central controller server 150 can update the standard wording table according to user's input to increase the accuracy of the solution searching system 100 in some embodiments of the present invention.

After the attribute description file is generated, the utility server 110 can pick up some of predictors from the attribute description file to generate the predictor file. The utility server 110 can further generate an input model file B1 according to the predictor file and the prediction model. For example, the utility server 110 can adjust the predictor file by removing the numbers in the predictor file according to the characteristic of the prediction model (ex., CBayes model) so the model input file B1 can be generated. Also, in other embodiments of the present invention, the different prediction models may have different requirements for the formats.

The central controller server 150 can transfer the model input file B1 generated by the utility server 110 to the model running server 120. The model running server 120 can generate a prediction solution classification P1 according to the model input file B1 and the data mining prediction model M1. The prediction solution classification P1 can be used for predicting to which solution classification the issue description file A1 belongs.

In some embodiments of the present invention, the solution classification may include a plurality of sub classifications. For example, the prediction solution classification P1 may be “bios.mrc.i2c”, where “bios” represents that the issue description file A1 is related to Basic Input/Output System (BIOS), “bios.mrc” represents that the issue description file A1 is related to memory reference code in the BIOS, and “bios.mrc.i2c” represents that the issue description file A1 is related to Inter-integrated circuit (I2C) in the memory reference code in the BIOS.

Since the prediction solution classification P1 generated by the model running server 120 may not always be correct, users may also store the classifications corresponding to the issue description file A1 to the relational database 160 by themselves, that is, the users may store their user defined solution classifications corresponding to the issue description file A1 to the relational database 160, if they already have certain understanding about the issue description file A1. Thus, the possibility to find the correct solution can be increased.

In other words, since different users may encounter the same issue and input the same issue description file when using the solution searching system 100, the accuracy of the solution searching system 100 may be further improved if the experience and understanding of each of the users can be combined. To let the experience and opinions from different users be the references of the search for next time, users are allowed to input their user defined solution classification corresponding to the issue description file in the solution searching system 100. In addition, considering that the users may have different degrees of understanding to the issue, the weightings of the users may be different from each other. Table 2 shows the relations between the identities of users and their weightings.

TABLE 2

| User identify | Weighting |
|---|---|
| Project manager | 5 |
| Technical manager | 4 |
| Senior engineer | 3 |
| Engineer | 2 |
| Junior engineer | 1 |
| General user | 0 |

For example, if the user U1 is a project manager and has a weighting of 5, then, when the user U1 inputs the user defined solution classification, such as S1, corresponding to the issue description file A1, the central controller server 150 may store the relation between the user defined solution classification S1 and the issue description file A1 in the relational database 160 and set the weighting of the user defined solution classification S1 corresponding to the issue description file A1 according to the identity of the user U1. If there is no other user inputted the same classification S1 before the user U1, then the central controller server 150 can set the weighting of the user defined solution classification S1 corresponding to the issue description file A1 to be the weighting of the user U1, that is 5 as shown in Table 2, in the relational database 160.

After the user U1 inputs the user defined solution classification S1 corresponding to the issue description file A1, if a user U2 with an identity as junior engineer also inputs the same user defined solution classification S1 corresponding to the issue description file A1, then the central controller server 150 can increment the weighting of the user defined solution classification S1 corresponding to the issue description file A1 according to the weighting of the user U2, that is 1 as shown in Table 2, in the relational database 160. In this case, the weighting will be 6 after being incremented.

Consequently, when selecting the solution classification, the central controller server 150 can check if there is at least one user defined solution classification corresponding to the issue description file A1 in the relational database 160. If there is no user defined solution classification corresponding to the issue description file A1 in the relational database 160, then the central controller server 150 may choose the prediction solution classification generated by the model running server 120 as the solution classification. In the embodiment shown in FIG. 1, since there are user defined solution classifications S1 and S2 corresponding to the issue description file A1 in the relational database 160, the central controller server 150 can choose the user defined solution classification having the highest weighting among the user defined solution classifications S1 and S2 to be the solution classification C1.

Furthermore, in some embodiments of the present invention, the data mining prediction model M1 can be built by the solution searching system 100 according to a plurality of solved issue description files and data mining algorithms. In addition to the information included in the issue description file A1, the solved issue description file may further include columns for the root cause of the system issue, match solution classification and corresponding solutions. Therefore, in addition to the user defined solution classification, the solution searching system 100 may also enhance its accuracy by using the information in the solved issue description files.

For example, the solution search system 100 can store the corresponding relation between the match solution classification and the solved issue description file stating the match solution classification to the relational database 160 for references in the future. The match solution classification may be the solution classification recorded by users previously. However, chances are that the range of the solution classification recorded by the users may be very wide, ex., the user may only denote “bios” as the solution classification of the solved issue description file, which may cause the number of the searched solutions to be too big to preserve the accuracy. Therefore, the solution searching system 100 can further enhance the match solution classification by comparing the column of root cause in the solved issue description file with the standard wording table so that the match solution classification can be even more specific.

In this case, when there is no user defined solution classification corresponding to the issue description file A1 stored in the relational database 160, but there is a match solution classification corresponding to the issue description file A1 stored in the relational database 160, the central controller server 150 can select the match solution classification as the solution classification. However, when there is no user defined solution classification and no match solution classification corresponding to the issue description file A1 stored in the relational database 160, the central controller server 150 can select the prediction solution classification P1 generated by the model running server 120 to be the solution classification.

For example, Table 3 shows the corresponding relation among the issue description files, the user defined solution classifications corresponding to the issue description files and the match solution classifications corresponding to the issue description files stored in the relational database 160 according to one embodiment of the present invention.

TABLE 3

| Serial code of issue | User defined solution | Match solution |
|---|---|---|
| description file | classification | classification |
| 01234 | S1: 6; | T1 |
| | S2: 3 | |
| 01235 | | T2 |
| 01236 | | |

In Table 3, each of the issue description file can be represented by serial code of the issue description file so that the issue description files can be searched and managed more conveniently. For example, since the serial code of the issue description file A1 is 01234, the central controller server 150 can use the serial code 01234 to search whether there is any match solution classification or user defined solution classification corresponding to the issue description file A1. In this case, the issue description file A1 can be corresponding to a solved issue description file in the solution searching system 100, therefore, the match solution classification T1 can be found according to the serial code 01234 of the issue description file A1. Furthermore, the user defined solution classifications S1 and S2 can also be found according to the serial code 01234 of the issue description file A1. The weightings of the user defined solution classifications S1 and S2 are 6 and 3 respectively as shown in Table 3. In this case, the central controller server 150 will select the user defined solution classification S1, which has a higher weighting, to be the solution classification when determining the solution classification of the issue description file A1.

In some embodiments of the present invention, when determining the solution classification of the issue description file with the serial code 01235, the central controller server 150 can select the match solution classification T2 as the solution classification of the issue description file since there is no user defined solution classification corresponding to the serial code 012345 of the issue description file in Table 3 but only the match solution classification T2. However, when determining the solution classification of the issue description file with the serial code of 01236, the central controller server 150 can select the prediction solution classification generated by the model running server 120 as the solution classification of the issue description file since there is no user defined solution classification corresponding to the serial code 012346 and no match solution classification corresponding to the serial code 012346 in Table 3, that is, the issue description file with the serial code 01236 has not been inputted by users before and there is no corresponding solved issue description file in the system for reference.

After the solution classification C1 is determined, the central controller server 150 can transfer the solution classification C1 to the database server 140, and the database server 140 can read at least one solution file from the big data database 130 according the solution classification C1. In the embodiment in FIG. 1, the big data database 130 stores the solution files D1₁ to D1₃ corresponding to the solution classification C1. The central controller server 150 can output the solution files D1₁ to D1₃ sequentially according to weightings of the solution file D1₁ to D1₃ corresponding to the solution classification C1 in the relational database 160. The higher the weighting of the solution file is, the more possible the solution file can help to solve the issue. Therefore, the user may use the solution file with the highest weighting and try to solve the issue firstly, and then use the solution with the second highest weighting and so on. Consequently, the efficiency for solving the issue can be further increased.

In some embodiments of the present invention, the weighting of each solution file D1₁ to D1₃ corresponding to the solution classification C1 can be set automatically in the solution searching system 100 by comparing the internal information, and can also be set according to the interaction with users. For examples, the solution searching system 100 can store the corresponding relation among the solution classification C1 and each of the solved issue description files corresponding to the solution classification C1, namely, the solution searching system 100 can store all the solved issue description files corresponding to the solution classification C1. Since the solved issue description files corresponding to the same solution classification C1 can be corresponding to different solution files and the solution files included in each of the solved issue description file may all be used to solve the issue described by the issue description file A1 potentially, the solution searching system 100 can find the solved issue description files according to the corresponding relation between the solution classification C1 and the corresponding solved issue description files, and the solution searching system 100 can take the solution files included in the solved issue description files just found as possible solution files after the central controller server 150 determines the proper solution classification C1.

Furthermore, the more similar the words in the solved issue description file are to the issue description file A1, the closer the two issues described by these two issue description files are, and, also, the more likely the solution included in the solved issue description can solve the issue in the issue description file A1. Therefore, the solution searching system 100 can compare the words in the solved issue description files to the words in the issue description file A1 in query and set the weightings of the solution files of the solved issue description files according to the similarity of the comparison result.

After the central controller 150 outputs the solution files D1₁ to D1₃ according to the weightings generated by the aforesaid process, the users can use and try the solution files D1₁ to D1₃ provided by the solution searching system 100 to solve their issues. In order to combine the experiences of different users to help the search of next user, the user can also evaluate the weightings of the solution files D1₁ to D1₃. The central controller server 150 can adjust a weighting of a solution file corresponding to the solution classification C1 in the relational database 160 according to the user's evaluation.

That is, after the user executes the solution file to solve the issue, the user can set the weighting of the solution file according to the degree of how the executed solution file is able to solve the issue. For example, Table 4 shows the relation between the weighting of the executed solution file and the degree of how the executed solution file is able to solve the issue.

TABLE 4

| | degree of how the executed |
|---|---|
| | solution file is able to solve |
| weighting | the issue |
| 0 | Not able to solve the issue at all |
| 1 | Is able to provide only a few clues |
| | for the users |
| 2 | Is able to provide some clues for |
| | the users |
| 3 | Is able to provide most of clues |
| | for the users |
| 4 | Is nearly able to solve the issue |
| 5 | Is able to solve the issue |
| | completely |

In Table 4, according to the degree of how the executed solution file is able to solve the issue, namely, from “Is able to solve the issue completely” to “Not able to solve the issue at all”, the weightings can be set to from 5 to 0. By allowing the users to evaluate the weightings and feedback to the system after the users execute the solution file, the weightings of the solution files D1₁ to D1₃ corresponding to the solution classification C1 can be assigned or incremented according to the evaluation result from different users. Therefore, when the same issue is queried by a user next time, the solution files D1₁ to D1₃ will be outputted according the weightings for the user, and the user can use the solution file and try to solve the issue according to the weightings so that the user may find the proper solution file for the encountered issue even faster and the accuracy of the solution searching system 100 can be further improved.

In addition, the solution searching system 100 can further include a web server 170. The user can input the issue description file A1 through a web page interface provided by the web server 170. After receiving the issue description file A1, the web server 170 can transfer the issue description file A1 to the central controller server 150, and output the solution file D1₁ to D1₃ outputted by the central controller server 150 on the web page interface.

According to the solution searching system 100 of the aforesaid embodiment, the engineers can share their experiences on how they used to solve the system issues, the possible solutions can be found easily using less time, and the quality of the solution files can also be improved.

In addition, to use the information inputted by the users efficiently, the solution searching system of the present invention may also use the information inputted by the users to update its prediction model for further improving the accuracy.

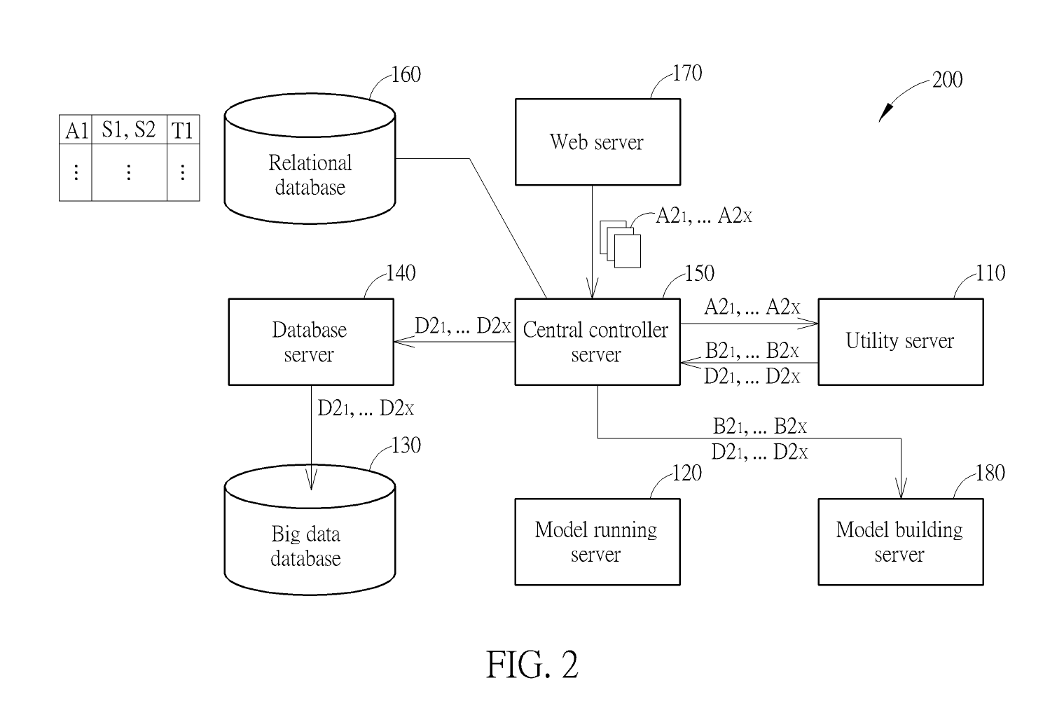

FIG. 2 shows a solution searching system 200 according to some embodiments of the present invention. The solution searching systems 200 and 100 can have the same operation principles. The difference between the solution searching systems 200 and 100 is in that the solution searching system 200 further includes a model building server 180. When the central controller server 150 receives a first predetermined number of solved issue description files A2₁ to A2_{X}, the standard wording table is updated, and/or the user defined solution classifications inputted by users reaches a second predetermined number, the central controller server 150 can control the utility server 110 and the model building server 180 to build new second data mining prediction model M2.

In FIG. 2, when the solution searching system 200 tries to build the new data mining prediction model, the central controller server 150 can transfer the solved issue description files A2₁ to A2_{X} to the utility server 110. The utility server 110 can generate the model input files B2₁ to B2_{X} and solution files D2₁ to D2_{X} corresponding to each of the solved issue description files A2₁ to A2_{X} according to the updated standard wording table, if any, and the solved issue description files A2₁ to A2_{X}.

The central controller server 150 can transfer the solution files D2₁ to D2_{X} corresponding to the solved issue description files A2₁ to A2_{X} to the database server 140 so the database server 140 can store the solution files D2₁ to D2_{X} to the big data database 130. Also, the central controller server 150 can transfer the model input files B2₁ to B2_{X} and the solution files D2₁ to D2_{X} corresponding to the solved issue description files A2₁ to A2_{X} to the model building server 180. The model building server 180 can build the new data mining prediction model M2 according to the model input files B2₁ to B2_{X} and the solution files D2₁ to D2_{X} generated by the utility server 110, a data mining algorithm and the corresponding relation between the user defined solution classifications and the issue description files stored in the relational database 160. In some embodiments of the present invention, the model building server 180 can use the data mining algorithm such as Bayes, CBayes or SGD to build the prediction model.

Since the process for building the data mining prediction model M2 may require much more time than the process for the model running server 120 to switch the data mining prediction model requires, the central controller server 150 can let the model running server 120 use the data mining prediction model M2 to replace the data mining prediction model M1 after the data mining prediction model M2 is built. Therefore, the user can still use the solution searching system 200 when the data mining prediction model M2 is under construction. In addition, during the period when the model running server 120 is switching the data mining prediction model M1 to the data mining prediction model M2, the web server 170 can output an updating progress notification so that the users can be aware of the progress of construction and transition. Also, during the period when the model running server 120 is switching the data mining prediction model M1 to the data mining prediction model M2, the solution searching system 200 can also provide functions unrelated to the data mining prediction model to make the solution searching system 200 even more convenient.

Since the data mining prediction model M2 is built according to the information inputted from the users previously, the updated solution searching system 200 can combine the experience of the users to further improve the accuracy. By continuously rebuilding the data mining prediction model, the accuracy of the prediction model used by the solution searching system of the present invention can be increased, and may finally reach an ideal level.

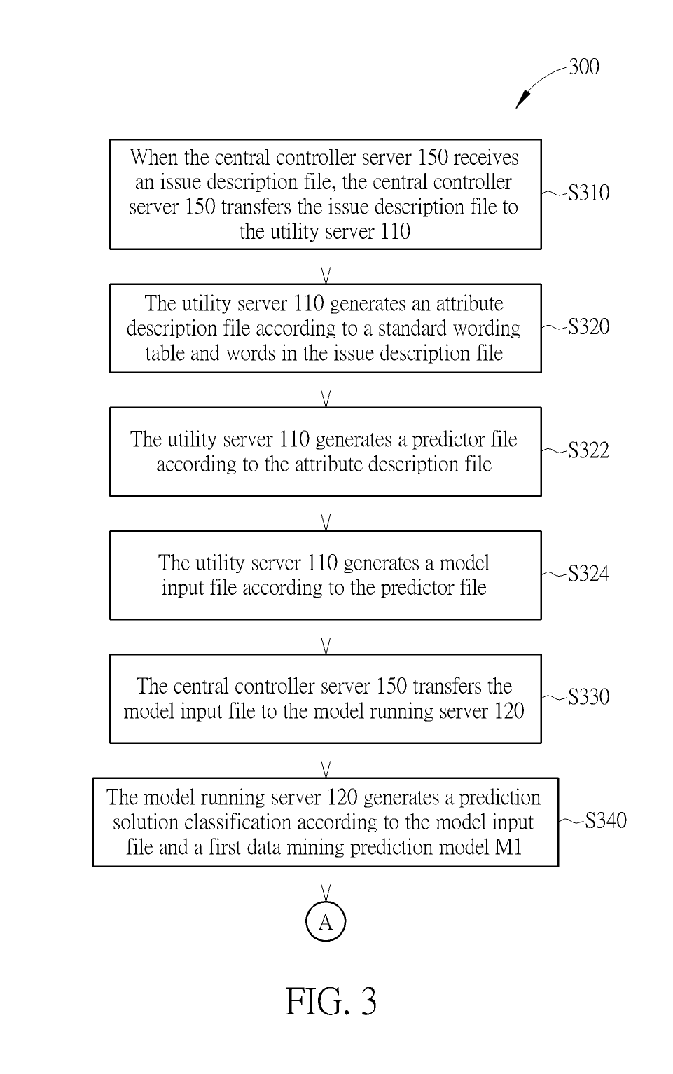

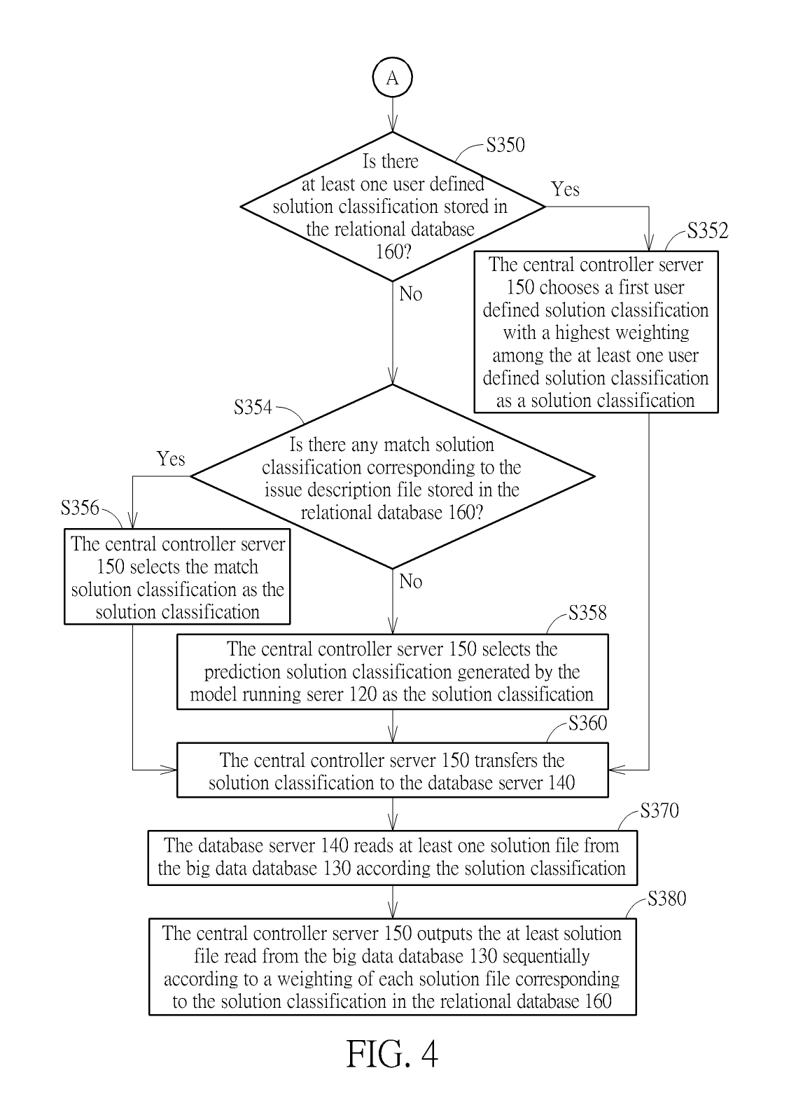

FIGS. 3 and 4 show a method 300 of operating the solution searching system 100 according to one embodiment of the present invention. The method 300 includes steps S310 to S380 as below:

S310: when the central controller server 150 receives an issue description file, the central controller server 150 transfers the issue description file to the utility server 110, and goes to step S320;

S320: the utility server 110 generates an attribute description file according to a standard wording table and words in the issue description file, and goes to step S322;

S322: the utility server 110 generates a predictor file according to the attribute description file, and goes to step S324;

S324: the utility server 110 generates a model input file according to the predictor file, and goes to step S330;

S330: the central controller server 150 transfers the model input file to the model running server 120, and goes to step S340;

S340: the model running server 120 generates a prediction solution classification according to the model input file and a first data mining prediction model M1, and goes to step S350;

S350: if there is at least one user defined solution classification stored in the relational database 160, goes to step S352; otherwise, goes to step S354;

S352: the central controller server 150 chooses a first user defined solution classification with a highest weighting among the at least one user defined solution classification as a solution classification, and goes to step S360;

S354: if there is no user defined solution classification corresponding to the issue description file stored in the relational database 160, but there is a match solution classification corresponding to the issue description file stored in the relational database 160, goes to step S356; otherwise, goes to step S358;

S356: the central controller server 150 selects the match solution classification as the solution classification, and goes to step S360;

S358: the central controller server 150 selects the prediction solution classification generated by the model running serer 120 as the solution classification, and goes to step S360;

S360: the central controller server 150 transfers the solution classification to the database server 140, and goes to step S370;

S370: the database server 140 reads at least one solution file from the big data database 130 according the solution classification, and goes to step S380; and

S380: the central controller server 150 outputs the at least solution file read from the big data database 130 sequentially according to a weighting of each solution file corresponding to the solution classification in the relational database 160.

According to the embodiments of the present invention, the solution searching systems 100 and 200 and the method 300 can help the engineers to share their experiences on how they solved the system issues before, search the possible solutions easily to save time, and can also improve the quality of the solutions by adopting the technics of big data and data mining.

In summary, the solution searching system and the method of operating the solution searching system according to the embodiments of the present invention can adopt the database for big data and the data mining algorithms to help the users to share their experiences on how they solved the system issues before, and can help the users to search the possible solutions when the users encounter system issues. Consequently, the inefficiency of the searching system and the difficulty of controlling the quality of solution in the prior are can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A solution searching system, comprising:
a big data database;
a relational database;
a utility server configured to generate an attribute description file according to a standard wording table and words in an issue description file, generate a predictor file according to the attribute description file, and generate a model input file according to the predictor file;
a model running server configured to generate a prediction solution classification according to the model input file and a first data mining prediction model;
a database server configured to read at least one solution file from the big data database according a solution classification corresponding to the issue description file; and
a central controller server configured to:
when receiving the issue description file, transfer the issue description file to the utility server;
transfer the model input file generated by the utility server to the model running server;
when there is at least one user defined solution classification stored in the relational database, choosing a first user defined solution classification with a highest weighting among the at least one user defined solution classification as the solution classification;
transfer the solution classification to the database server; and
output the at least one solution file read by the database server from the big data database sequentially according to a weighting of each solution file corresponding to the solution classification in the relational database.

2. The solution searching system of claim 1, wherein the central controller server is further configured to:
when a first user inputs the first user defined solution classification corresponding to the issue description file, store a corresponding relation between the first user defined solution classification and the issue description file to the relational database, and set a weighting of the first user defined solution classification corresponding to the issue description file according to an identity of the first user.

3. The solution searching system of claim 2, wherein the central controller server is further configured to:
after the first user inputs the first user defined solution classification corresponding to the issue description file, when a second user inputs the first user defined solution classification corresponding to the issue description file, increase the weighting of the first user defined solution classification corresponding to the issue description file according to an identity of the second user.

4. The solution searching system of claim 1, wherein the central controller server is further configured to:
when there is no user defined solution classification corresponding to the issue description file stored in the relational database, but there is a match solution classification corresponding to the issue description file stored in the relational database, select the match solution classification as the solution classification; and
when there is no user defined solution classification and no match solution classification corresponding to the issue description file stored in the relational database, select the prediction solution classification as the solution classification.

5. The solution searching system of claim 1, wherein the central controller server is further configured to update the standard wording table according to a user's input information.

6. The solution searching system of claim 1, wherein the central controller server is further configured to set a weighting of an executed solution file corresponding to the solution classification according to a degree of how the executed solution file of the at least one solution file inputted by a user is able to solve an issue.

7. The solution searching system of claim 1, wherein the central controller server is further configured to:
when the central controller server receives a first predetermined number of solved issue description files, the standard wording table is updated, and/or the user defined solution classification inputted by a user reaches to a second predetermined number, control a model building server to build a second data mining prediction model according to data generated by the utility server, a data mining algorithm and a corresponding relation between the first user defined solution classification and the issue description file stored in the relational database; and
after the second data mining prediction model is built, let the model running server use the second data mining prediction model to replace the first data mining prediction model.

8. The solution searching system of claim 1, further comprising a web server configure to provide a web page interface for receiving the issue description file, transfer the issue description file to the central controller server, output the solution file outputted by the central controller server on the web page interface, and output an updating progress notification during the model running server using the second data mining prediction model to replace the first data mining prediction model.

9. A method for operating a solution searching system, the solution searching system comprising a utility server, a model running server, a relational database, a big data database, and a central controller server, the method comprising:
when the central controller server receives an issue description file, the central controller server transferring the issue description file to the utility server;
the utility server generating an attribute description file according to a standard wording table and words in the issue description file;
the utility server generating a predictor file according to the attribute description file;
the utility server generating a model input file according to the predictor file;
the central controller server transferring the model input file to the model running server;
the model running server generating a prediction solution classification according to the model input file and a first data mining prediction model;
when there is at least one user defined solution classification stored in the relational database, the central controller server choosing a first user defined solution classification with a highest weighting among the at least one user defined solution classification as a solution classification;
the central controller server transferring the solution classification to the database server;
the database server reading at least one solution file from the big data database according the solution classification; and
the central controller server outputting the at least solution file read by the database server from the big data database sequentially according to a weighting of each solution file corresponding to the solution classification in the relational database.

10. The method for operating the solution searching system of claim 9, further comprising:
when a first user inputs the first user defined solution classification corresponding to the issue description file, the central controller server storing a corresponding relation between the first user defined solution classification and the issue description file to the relational database, and setting a weighting of the first user defined solution classification corresponding to the issue description file according to an identity of the first user.

11. The method for operating the solution searching system of claim 10, further comprising:
after the first user inputs the first user defined solution classification corresponding to the issue description file, when a second user inputs the first user defined solution classification corresponding to the issue description file, the central controller server increasing the weighting of the first user defined solution classification corresponding to the issue description file according to an identity of the second user.

12. The method for operating the solution searching system of claim 9, further comprising:
when there is no user defined solution classification corresponding to the issue description file stored in the relational database, but there is a match solution classification corresponding to the issue description file stored in the relational database, the central controller server selecting the match solution classification as the solution classification; and
when there is no user defined solution classification and no match solution classification corresponding to the issue description file stored in the relational database, the central controller server selecting the prediction solution classification as the solution classification.

13. The method for operating the solution searching system of claim 9, further comprising the central controller server updating the standard wording table according to a user's input information.

14. The method for operating the solution searching system of claim 9, further comprising:
the central controller server setting a weighting of an executed solution file corresponding to the solution classification according to a degree of how the executed solution file of the at least one solution file inputted by a user is able to solve an issue.

15. The method for operating the solution searching system of claim 9, wherein the solution searching system further comprises a model building server, and the method further comprises:
when the central controller server receives a first predetermined number of solved issue description files, the standard wording table is updated, and/or the user defined solution classification inputted by a user reaches to a second predetermined number, the central controller server controlling a model building server to build a second data mining prediction model according to data generated by the utility server, a data mining algorithm and a corresponding relation between the first user defined solution classification and the issue description file stored in the relational database; and
after the second data mining prediction model is built, the central controller server letting the model running server use the second data mining prediction model to replace the first data mining prediction model.
